(19) United States
(12) Patent Application Publication
(10) Pub. No.: US 2010/0011036 A1
(43) Pub. Date: Jan. 14, 2010

(54) DOCUMENT STORAGE ACCESS ON A PER-APPROVAL BASIS

(75) Inventor: Eric Wagner, Scottsdale, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 12/170,352

(22) Filed: Jul. 9, 2008

(51) Int. Cl. G06F 12/00; G06F 15/16

(52) U.S. Cl. 707/205; 709/206; 707/E17.01; 711/E12.001

(57) ABSTRACT

Systems and methods of the present invention allow a file owner to upload and store a file to a File Storage Area. Through a series of communications, a file requestor may request access to the file. The file owner may grant or deny permissions to access the file and notify the file requestor of the results.

### CROSS REFERENCE TO RELATED PATENT APPLICATIONS

This patent application is related to the following concurrently-filed patent applications:

U.S. patent application Ser. No. ______, “DOCUMENT STORAGE ACCESS ON A TIME-BASED APPROVAL BASIS.”

The subject matter of all patent applications is commonly owned and assigned to The Go Daddy Group, Inc. All applications are incorporated herein in their entirety by reference.

### FIELD OF THE INVENTION

The present inventions generally relate to the field of online storage and, more specifically, systems and methods for safekeeping documents and files stored online.

### BACKGROUND OF THE INVENTION

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers place multimedia information (e.g., text, graphics, audio, video, animation, and other forms of data) at specific locations on the Internet referred to as websites. The combination of all the websites and their corresponding web pages on the Internet is generally known as the World Wide Web (WWW) or simply the Web. The Internet or the World Wide Web may be used as a tool to store and share files with other users of the Internet.

### SUMMARY OF THE INVENTION

The present invention provides systems and methods for the safekeeping of files and documents, thus overcoming substantial limitations in the relevant art. In an example embodiment, a file owner may store a file or other documents or software online. Through a series of communications between a file requestor and the file owner, the file may be shared with the file requestor.

An exemplary system for safeguarding online files may include a File Storage Area containing at least one File. The File Storage Area may be accessible by a file owner after proper authentication, may be hosted by a Hosting Provider and may be communicatively coupled to a Network. A Link may be used to access the File and the Link or the other means of accessing the File may contains information about one or more access permissions associated with the File. A File Requestor Interface communicatively coupled to the Network may be accessible to a file requestor. This File Requestor Interface may contain means for requesting access to the File, means for notifying the file requestor of a response to a request for access to the File, and means for accessing the File. Likewise, a File Owner Interface communicatively coupled to the Network may be accessible to the file owner. This File Owner Interface may contain a Control Panel including viewing and editing capabilities for the File and its associated access permissions, means for notifying the file owner of the request for access to the File, means for granting or denying the request for access to the File and means for responding to the file requestor regarding the request for access to the File.

An exemplary method of safeguarding online files may include the steps of providing a File Storage Area containing at least one File belonging to a file owner wherein the file owner may, after proper authentication, grant or deny access to the File, allowing a file requestor to request access to the File from the file owner, notifying the file owner of the request to access the File, providing means for the file owner to view and edit the File and any associated access permissions and to respond to the request to access the File by granting or denying the request to access the File and communicating the response to the file requestor, providing means for the file requestor to access the File, subsequent to a grant of access to the File and removing the means for the file requestor to access the File, subsequent to the file requestor successfully accessing the File.

An exemplary system for safeguarding online files may include a File Storage Area containing at least one File. This File Storage Area may be accessible by a file owner after proper authentication, may be hosted by a Hosting Provider and may be communicatively coupled to a Network. At least one Time-Based Approval Period may be created, during which the file owner may or may not grant or deny the file requestor one or more access permissions to access the File. After expiration of the Time-Based Approval Period, the file requestor may automatically access the File with or without additional limitations. A File Requestor Interface communicatively coupled to the Network may be accessible to a file requestor. This File Requestor Interface may contain means for requesting access to the File, means for notifying the file requestor of the Time-Based Approval Period associated with the File and means for accessing the File during or after the Time-Based Approval Period. Likewise, a File Owner Interface communicatively coupled to the Network may be accessible to the file owner. This File Owner Interface may contain a Control Panel including viewing and editing capabilities for the File, any associated access permissions, any Time-Based Approval Periods and file owner contact information, means for notifying the file owner of a request for access to the File and any pending Time-Based Approval Periods, means for granting or denying the request for access to the File during the Time-Based Approval Period, means for granting the request for access to the File after the Time-Based Approval Period and means for responding to the file requestor regarding the request for access to the File.

An exemplary method of safeguarding online files may include the steps of providing a File Storage Area containing at least one File belonging to a file owner wherein the file owner may, after proper authentication, grant or deny access to the File during a Time-Based Approval Period, and after which the file requestor may automatically access the File with or without additional limitations, providing means for the file owner to view and edit the File, any associated access permissions and any related Time-Based Approval Periods, and to respond to any request to access the File during the Time-Based Approval Period by granting or denying the request to access the File and communicating the response to the file requestor, maintaining open communication with the file owner or requiring proper authentication regularly to ensure open communication with the file owner, notifying the file owner at least once that failure to maintain open communication or to respond to a request during the Time-Based Approval Period will allow the requestor to access the File to be approved by default and providing means for accessing the File by default after expiration of the Time-Based Approval Period.

The above features and advantages of the present invention will be better understood from the following detailed description taken in conjunction with the accompanying drawings.

### BRIEF DESCRIPTION OF THE DRAWINGS

FIG. 1 illustrates a possible embodiment of a system for safeguarding documents online.

FIG. 2 illustrates a possible embodiment of a system for safeguarding documents online.

FIG. 3 is a flow diagram illustrating a possible embodiment of a method for safeguarding documents online.

FIG. 4 illustrates a possible embodiment of a system for safeguarding documents online.

FIG. 5 is a flow diagram illustrating a possible embodiment of a method for safeguarding documents online.

### DETAILED DESCRIPTION

The present inventions will now be discussed in detail with regard to the attached drawing figures which were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

A Streamlined System for Document Storage Access

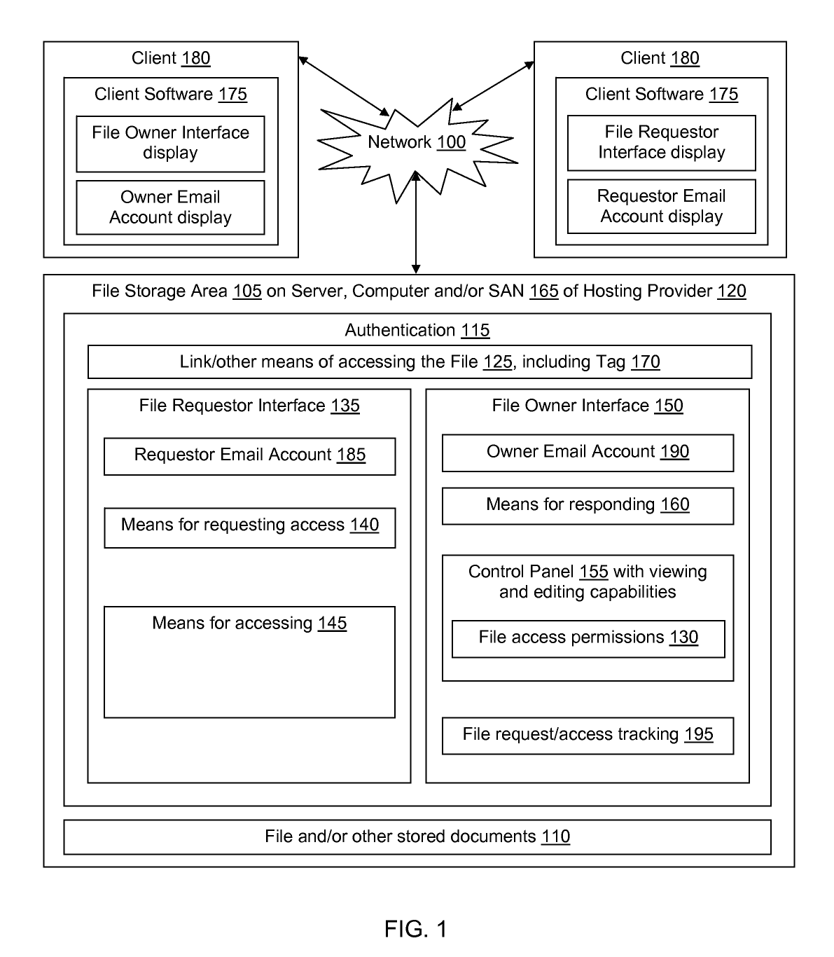

As shown in a streamlined example embodiment of a document storage access system in FIG. 1, the system for document storage access may include a Network 100. A File Storage Area 105 containing one or more Files 110 or other stored documents may be hosted by a Hosting Provider 120 and communicatively coupled to the Network 100.

The example embodiments herein place no limitation on network configuration or connectivity. Thus, as non-limiting examples, the Network 100 may be the Internet, an intranet, an extranet, a local area network, a wide area network, a wired network, a wireless network, a telephone network, any other network now known or later developed in the art or any combination thereof.

The File Storage Area 105 may be any means of storage for storing files or other information. The File Storage Area 105 may be online, which may include the Internet, but also including any Intranet or other Network 100 of computers or servers. As shown in the streamlined example embodiment shown in FIG. 1, the File Storage Area 105 may be used for storing files, documents, backups, applications/other install packages, web pages, commands, software or any other needed means of online or offline storage space, or any combination thereof. The File Storage Area 105 may also include any combination of hard drives, RAM or other computer memory storage devices that are known in the art.

The File and/or other stored documents 110 may likewise include, but are not limited to one or more files, documents, backup applications/software, applications/other install packages, web pages, commands, software, text files, multimedia, graphics, audio files, video files, animation files or any combination thereof.

The File Storage Area 105 may further be part of a Storage Area Network (SAN) 165 wherein a hosting computer and/or server may be communicatively coupled with at least one additional computer 165 to provide additional storage space to the File Storage Area 105 or any other storage areas as needed by the file owner.

The Hosting Provider 120 may provide hosting services including, but not limited to hosting one or more Servers, Computers and/or SAN 165 in a data center as well as providing the general infrastructure necessary to offer hosting services to Internet users including hardware, software, Internet web sites, hosting servers, and electronic communication means necessary to connect multiple Servers, Computers and/or SAN 165 to the Internet or any other Network 100.

The file owner, as well as the file requestor, may be an individual or an entity including, but not limited to, a person, a business, a governmental institution, an educational institution, a non-profit organization, or a social organization or any other individual or organization capable of using the File and/or other stored documents 110.

Authentication 115 may be any means of attempting to verify the identity of the sender of a communication, such as a request to log in or access a resource. The thing being authenticated may be, but is not limited to, a person using a system, a computer itself, or a computer program.

As non-limiting examples, Authentication 115 may utilize any weak or strong authentication system known in the art or developed in the future, such as username/password, challenge/response, OpenID, MICROSOFT CARDSPACE, any Single Sign-On (SSO) methodology, Public Key Infrastructure (PKI), digital signatures, zero-knowledge proofs, Kerberos, smart card, biometrics (retina, voice, fingerprint, or DNA recognition) and/or any combination thereof. The authentication environment may further be secured with antivirus software, firewalling and/or at least one virtual private network.

The Server, Computer and/or SAN 165, as well as any complimentary Client 180, and the software utilized by any of the aforementioned may be communicatively coupled to the Network 100 via any method of network connection known in the art or developed in the future including, but not limited to wired, wireless, modem, dial-up, satellite, cable modem, Digital Subscriber Line (DSL), Asymmetric Digital Subscribers Line (ASDL), Virtual Private Network (VPN), Integrated Services Digital Network (ISDN), X.25, Ethernet, token ring, Fiber Distributed Data Interface (FDDI), IP over Asynchronous Transfer Mode (ATM), Infrared Data Association (IrDA), wireless, WAN technologies (T1, Frame Relay), Point-to-Point Protocol over Ethernet (PPPoE), and/or any combination thereof.

In a non-limiting example embodiment, the File Storage Area 105 may include a browser-based application that allows the file owner to store and access important files online, similar to how a file or folder on a hard drive may be stored and accessed. The File Storage Area 105 may provide functions for uploading, finding, managing and organizing the file owner's files, including means for granting or denying limited access requests.

Once authenticated, the file owner may have and give access to particular Files 110 stored in the File Storage Area 105. The file owner or other users may then perform actions on the Files 110 in the manner authorized to and by the user, such as transmitting the files as attachments to emails or transmitting the files to any complimentary client.

As shown in FIG. 1, a Link or other means of accessing the File 125 may be used to view, edit and/or access the File 110. This Link or other means of accessing the File 125 may further include a Tag 170 or other means of embedding information about one or more access permissions associated with the File 110. Thus, the Link or other means of accessing the file 125 may be utilized in requesting access to the File 110, granting or denying access to the request, and/or accessing the File 110 for download or transfer once access to the File 110 has been granted.

The Link or other means of accessing the File 125 may be a reference or navigation element in a document to another section of the same document or to another document that may be on or part of a different domain. Additional means for accessing the file may also be used, including, but not limited to a menu used to select the File 110 from a list of choices; an icon or other graphical image used to represent the File 110, possibly including an embedded Link 125; a widget or control, including but not limited to a text-box, button, hyper-link, drop-down list, check-box, radio button, data grid, etc. or any other means of accessing a File 125 now known or later developed in the art. The viewing, editing and/or accessing of the File 110 may be accomplished by using the Link or other means of accessing the File 125.

The Tag 170 associated with the Link or other means of accessing the file 125 may be one or more non-hierarchical keywords, terms, phrases, HTML tag attributes or any other means of marking the Link 125 to accommodate the request, permissions and access of the File 110 in such a way that it may be assigned to the Link or any of the means of accessing the File 125 described above.

This kind of metadata (or data about data, in this case, data about the File 110 and it's respective File access permissions 130) may help describe the item, may allow it to be tracked for purposes of recording File 110 requests and access, or may carry information utilized in requesting access to the File 110, granting or denying access to the request, and/or accessing the File 110 for download or transfer once access to the File 110 has been granted. Tags may be assigned according to the file requestor when the file is requested or accessed or according to the file owner when a grant or denial of File access permissions 130 is given by the file owner.

The File Storage Area 105 may include a File Requestor Interface 135 and a File Owner Interface 150, accessible to the file requestor and the file owner respectively, possibly after Authentication 115 described above. Various communications between the file requestor and the file owner may allow the File 110 to be accessed by the file requestor.

In one non-limiting embodiment, these communications may be via a Requestor Email Account 185 assigned to the file requestor and/or an Owner Email Account 190 assigned to the file owner. The Requestor Email Account 185 and the Owner Email Account 190 may be capable of displaying and sending, respectively, the Link or other means of accessing the File 125 and any associated message.

Communications may be by any means of telecommunication now known or later developed in the art (text, IM, mobile phones, desktop notification, monthly ping, etc.), and any reference to email or email accounts within this disclosure may also be accomplished using these forms of communication. Such communications may be any assisted transmission of signals over a distance for the purpose of communication, and may involve, but are not limited to email, text messaging, instant messaging, desktop notification, monthly ping, etc. using electronic transmitters such as the telephone, mobile phone, Bluetooth, television, radio, computers, the Internet or any combination thereof possibly working together in a Network 100 as described elsewhere in this disclosure.

In one embodiment, the Link or other means of accessing the File 125, described elsewhere in this disclosure may be transmitted back and forth between the file requestor and file owner using the means of communication described above and embedded with the Tag 170 or other information about the one or more File access permissions 130. Such access permissions may be on a per-approval basis or time based, described in more detail in embodiments elsewhere in this disclosure.

In a non-limiting example embodiment, after uploading the File 110 to the File Storage Area 105, the File 110 may be shared with others via Links 125 to the selected File 110 sent by the file owner or requested by the file requestor, thereby allowing recipients to access download and/or transfer the File 110. This process may take place at the initial uploading of the shared File 110 or thereafter. To send such a Link 125, the organization of the File Storage Area 105 may be navigated to find a folder containing the File 110 to share. The files may be selected from a displayed list, perhaps by using checkboxes displayed next to the desired files, and a command, possibly in the form of a drop-down box or button, may be used to share the selected files. The file owner may then specify an email address to which the Link 125 may be sent and that Link 125 may then be used to access, download and/or transfer the File 110.

As shown in FIG. 1, The File Requestor Interface 135 and the File Owner Interface 150 may be user interfaces, accessible after Authentication 115, used to communicate with one another and control the elements within each interface. The user interfaces may be any aggregate of means by which users such as the file requestor or file owner interact with the system, such as a particular machine, device, computer program or other complex tools.

In addition, the user interfaces may be graphical, textual and/or auditory information a computer program presents to the file requestor or file owner, and the control sequences (keystrokes, movements of the computer mouse, selections with a touch screen etc.) the user employs to control the program. Non-limiting examples of such interfaces include Graphical user interfaces (GUI), Web-based user interfaces, Touch interfaces, Conversational Interface Agents, Live user interfaces (LUI), Command line interfaces, Non-command user interfaces, Object-oriented User Interfaces (OOUI), Voice user interfaces, any other user interfaces now known or later developed in the art, or any combination thereof.

The File Owner Interface 150 may further include a Control Panel 155 with viewing and editing capabilities. This Control Panel 155 may be a computer user interfaces which utilizes a control panel metaphor to allow the user control of software and hardware features. The file requestor or file owner may use the Control Panel 155 to add, remove or reinstall an application, change passwords, set basic configuration settings, migrate applications between different control panels or even restart related hardware or software, as well as providing any other control-panel related utilities now known or later developed in the art.

The Control Panel 155 within the File Owner Interface 150 may also allow the file owner to easily upload, save, organize and manage files stored in a File Storage Area 105. The user may upload from or copy files to a Client 180. The file owner may then access the File 110 from any Client 180. Desired applications may also be run, edited or archived by the file owner at the Client 180.

In a non-limiting example embodiment, Control Panel 155 within the File Owner Interface 150 may include a User Interface (UI) with a list of all available Files and/or other stored documents 110. It may also include settings interfaces such as a UI for document storage controls, settings controls and sharing controls. The sharing controls may further include a shared link creator/viewer/editor UI, an automatic access creator/viewer/editor UI, and a limited access to document creator/viewer/editor UI.

The Control Panel 155 may further include one or more access permissions associated with the File 110. These File access permissions 130 may include administrative permissions or access rights to specific users and groups of users. These systems may control the ability of the users affected to view or make changes to the contents of the file system.

In a non-limiting example embodiment, the automatic access creator UI and the limited access document UI may control two possible divisions between the File access permissions, including automatic file access permissions and limited file access permissions. The files associated with these permissions may likewise fall into two categories: automatic access files and limited access files. Limited access files may further include a per-approval group of limited access documents or a time based or safekeeping services (such as document delivery at death) group of limited access documents. The sharing controls UI may create a link to be shared and the file owner may be allowed to specify whether the link would automatically grant access to the document, or whether the link would trigger one of the limited access scenarios.

The divisions of the limited access files and the subdivisions of per-approval and time-based documents may create a type of extra security to require for document safekeeping. Only the limited documents in the division appropriate to the file owner or file requestor's File access permissions 130 may be shown and/or accessed by the file owner or file requestor respectively. Such document safekeeping options may be set as part of the file settings within the Control Panel 155.

In both the per-approval and time-based embodiments, the communications between the file requestor and file owner, as well as the File Requestor Interface 135 and the File Owner Interface 150 on a general purpose computer may be used together to create a Means for requesting access 140 to the File 110 by the file requestor; a Means for responding 160 by the file owner to the file requestor; and if the file requestor then has access to the File access permissions 130, a Means for accessing 145 the File 110. In one non-limiting example embodiment, the Means for responding 160 includes means for notifying the file requestor that the request to access the File 110 has been received by the file owner.

The File Owner Interface 150 may further include File request/access tracking 195 which may be a means for tracking both requests for access to the File 110 and actual access to the File 110. These services may be used by file owners trying to track how the stored information is accessed and may allow owners to very carefully track who has requested access to and accessed the File and/or other stored documents 110.

The File Requestor Interface 135 and the File Owner Interface 150 may be displayed in conjunction with Client Software 175 on a Client 180 communicatively coupled to the Network 100. The Client 180 may be any computer or program that provides services to other computers, programs, or users either in the same computer or over a computer Network 100. As non-limiting examples, the Client 180 may be an application, communication, mail, database, proxy, fax, file, media, web, peer-to-peer, or standalone computer which may contain an operating system, a full file system, a plurality of other necessary utilities or applications or any combination thereof on the Client 180.

A Client 180 may be any application or system including a computer, laptop, telephone, handheld device, etc. that accesses a service (possibly a remote service) on another computer system, generally, but not limited to a server or some type of hosting computer by way of a Network 100 and/or devices that may or may not be capable of running their own stand-alone programs. The client may be a thick (also known as fat or rich) client, a thin client or a hybrid client, which is a mixture of a thick and thin client, in that it processes locally, but relies on a server for storage data.

Non limiting example programming environments for Clients 180 may include JavaScript/AJAX (client side automation), ASP, JSP, Ruby on Rails, Python's Django, PHP, HTML pages or rich media like Flash, Flex or Silverlight.

Client Software 175 may be used for authenticated remote access to a hosting computer or server. These may be, but are not limited to being accessed by a remote desktop program and/or a web browser, as are known in the art.

In one non-limiting example embodiment, the File Storage Area 105 may have the ability to transmit, receive and/or store files either received from or transmitted to the Client 180 over a Network 100. The Client 180 and Client Software 175 may transmit a file from the Client 180 to be stored in the File Storage Area 105, which may then be moved to any additional Client 180.

The File Storage Area 105 and the means of transferring, uploading downloading and accessing files may further be used as a marketing tool wherein the service is provided as a method to drive long term subscriptions to subscriptions for the Hosting Provider 120, or may be a means of creating additional revenue for the Hosting Provider 120 via charges separate from or as an add-on to services currently provided.

A System for Approved Document Storage Access

As shown in a streamlined example embodiment of a document storage access system in FIG. 1, the system for document storage access may include a File Storage Area 105 containing at least one File and/or other stored documents 110 wherein the File Storage Area 105 is accessible by a file owner after proper Authentication 115, is hosted by a Hosting Provider 120 and is communicatively coupled to a Network 100. A Link 125 or other means of accessing the File 110 may be included in the File Storage Area 105 wherein the Link 125 or the other means of accessing the File 110 contains information about one or more File access permissions 130.

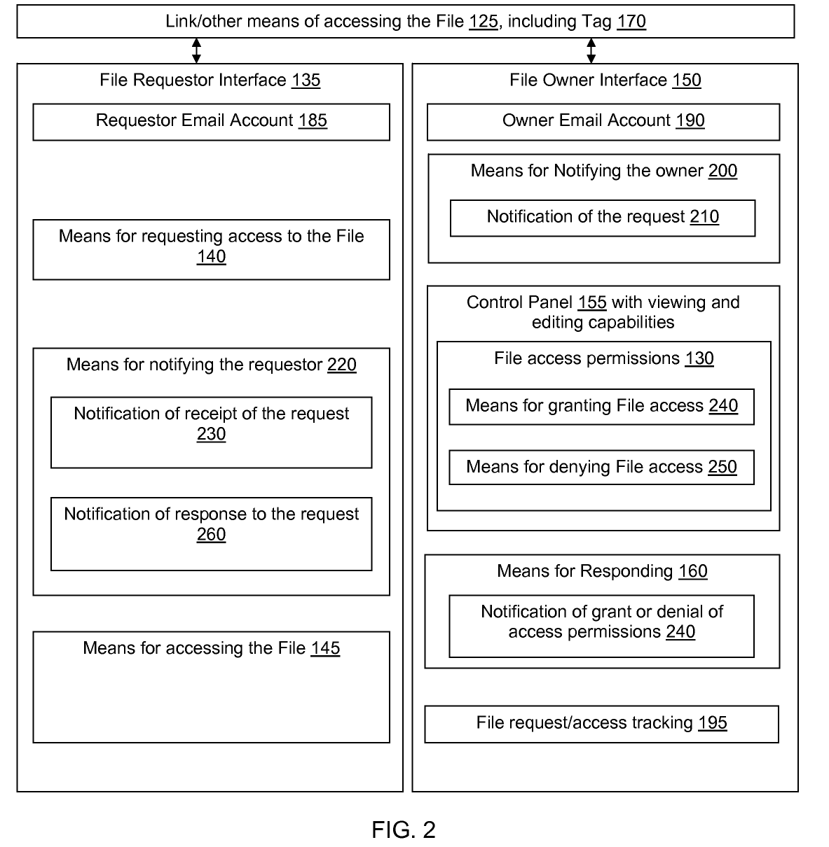

As shown in the streamlined example embodiment shown in FIG. 1 and the more detailed example embodiment shown in FIG. 2, a File Requestor Interface 135 including a Requestor Email Account 185, and a File Owner Interface 150 including an Owner Email Account 190 and a Control Panel 155 with viewing and editing capabilities may be included as part of the File Storage Area 105.

As previously described, the communications between the file requestor and file owner, as well as the File Requestor Interface 135 and the File Owner Interface 150 are used together to create a Means for requesting access 140 to the File 110 by the file requestor, a Means for responding 160 by the file owner to the file requestor, and if the file requestor is granted access to the File access permissions 130 by the file owner, a Means for accessing 145 the File 110. The details of the File Storage Area 105, the File Requestor Interface 135, the File Owner Interface 150 and the communications between the file requestor and file owner are described in detail elsewhere in this disclosure.

To accomplish these steps of requesting, responding and accessing, the File Owner Interface 150 may include a Means for notifying the file owner 200. The Means for notifying the file owner 200 may include a Notification of the request 210 for File access permissions 130. The Requestor Interface 135 may likewise include a Means of notifying the file requestor 220. The means for notifying the requestor 220 may further include a Notification of the receipt of the request 230 by the file owner.

The file owner may then use the viewing and editing capabilities of the Control Panel 155 or other elements of the File Owner Interface 150 as a Means for granting File access 240 or a Means for denying File access 250 in order to grant or deny File access permissions 130 respectively to the file requestor. The Means for responding 160 within the File Owner Interface 150 may then be used to send a Notification of the grant or denial of access permissions 240 to the file requestor.

The Means for notifying the requestor 220 within the File Requestor Interface 135 may be used to present to the file requestor Notification of a response to the request 260. The Link 125 or other means of accessing the File 110 may be used as a Means for accessing the File 145, including downloading, transferring or any other means of accessing a file now known or later developed in the art.

A Method for Approved Document Storage Access

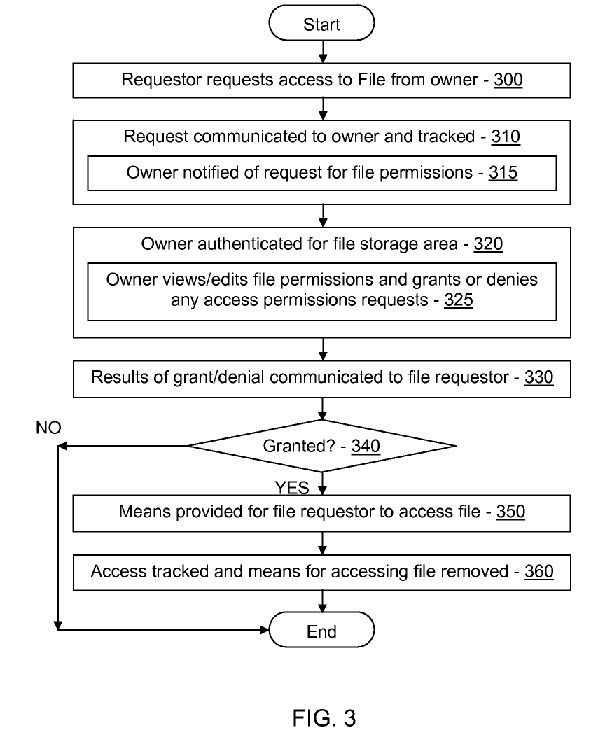

Several different methods may be used to provide and manage the disclosed invention. In an example embodiment illustrated in FIG. 3, a File Storage Area 105 may be provided containing at least one File 110 belonging to a file owner wherein the file owner may, after proper Authentication 115, grant or deny access to the File 110.

The process starts by allowing a file requestor to request access to the File 110 from the file owner (Step 300). The request is then communicated to the file owner and tracked (Step 310), possibly using the File request/access tracking 195 within the File Owner Interface 150. The file owner may be notified of the request by the file requestor for permissions to access the File 110 (Step 315).

The file owner may then be properly authenticated for the file storage area (Step 320). This Authentication 115 may allow access to the File Storage Area 105, the File Owner Interface 150 and/or the Control Panel 155. By doing so, the file owner may be provided means to view and/or edit any file permissions associated with the File 110, and may grant or deny any requests for access permissions to the File 110 (Step 325). The file owner may then respond to the request to access the File 110 by granting or denying the request to access the File 110 and communicating the response to the file requestor (Step 330).

If a determination is made that the access permissions are not granted (Step 340), the process ends. However, if a determination is made that the access permissions are granted (Step 340), means may be provided for the file requestor to access the File 110 (Step 350), subsequent to a grant of access to the File 110. Once the file has been successfully accessed by the file requestor the access of the file may be tracked, and subsequently the means for the file requestor to access the file may be removed (Step 360). Removal of the means for the file requestor to access the file may further include removal of the metadata tag or other information regarding the access permissions, or a removal of the Link 125 or other means of accessing the file, so that it is no longer available.

In a non limiting example, including a simple approval for each request, an email may be sent from the Requestor Email Account 185 to the Owner Email Account 190 containing a request for limited access to the File and/or other stored documents 110. A Link 125 or other means of accessing the File containing a Tag 170 may be sent to the file requestor in response to, or as the initial step of, the request.

When the sent Link 125 is clicked by the recipient, the File Storage Area 105 may notify the file owner of the request. It may also tell the file requestor that the approval process has begun. The owner may log into the Control Panel 155 of the File Owner Interface 150, possibly accessing an “approvals” section of the sharing controls UI, and may respond yes or no to the request. If approved, the Link 125 may be tagged so that the next request for that document may start the download. An email may be sent to the file requestor telling them of the results. If access to the File access permissions 130 is approved, the file requestor may click the Link 125 again and the document will download. The File Storage Area 105 may either remove the approved status from that Link 125, or may remove that link altogether. This type of approval control may allow owners to track who has accessed the documents.

A System for Time-Based Document Storage Access

As shown in a streamlined example embodiment of a document storage access system in FIG. 1, the system for document storage access may include a File Storage Area 105 containing at least one File and/or other stored documents 110 wherein the File Storage Area 105 is accessible by a file owner after proper Authentication 115, is hosted by a Hosting Provider 120 and is communicatively coupled to a Network 100. A Link 125 or other means of accessing the File 110 may be included in the File Storage Area 105 wherein the Link 125 or the other means of accessing the File 110 contains information about one or more File access permissions 130.

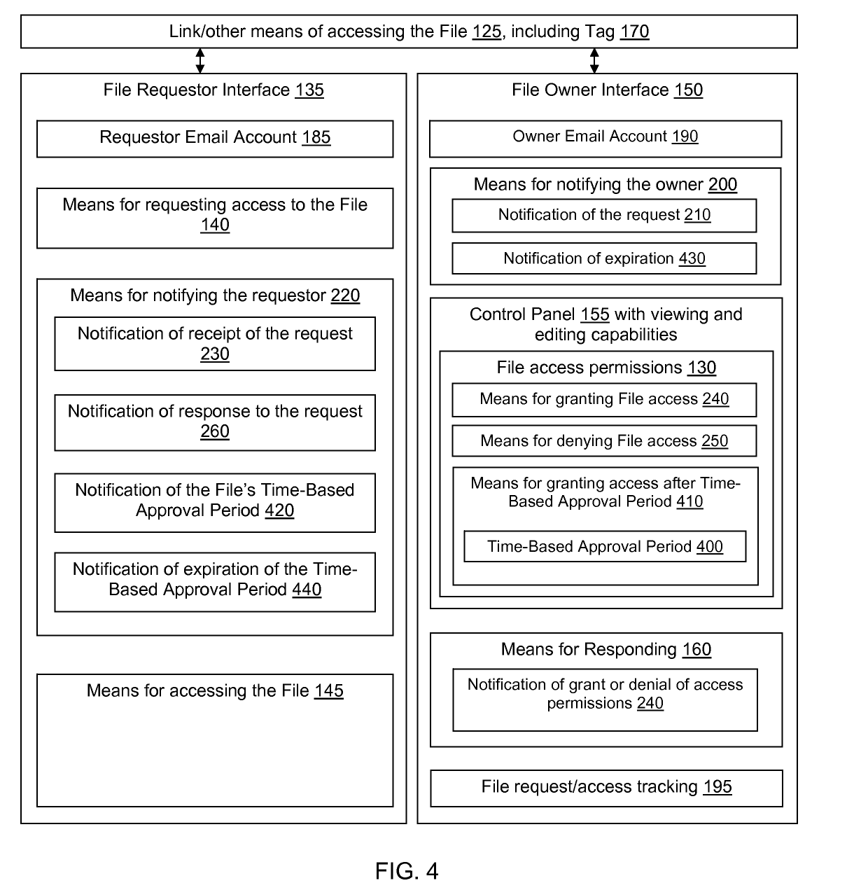

As shown in the streamlined example embodiment shown in FIG. 1 and the more detailed example embodiment shown in FIG. 4, a File Requestor Interface 135 including a Requestor Email Account 185, and a File Owner Interface 150 including an Owner Email Account 190 and a Control Panel 155 with viewing and editing capabilities may be included as part of the File Storage Area 105. In addition to the Owner Email Account 190, additional contact information may be viewed and edited by the file owner through the Control Panel 155 or through other elements of the File Owner Interface 150.

As previously described, the communications between the file requestor and file owner, as well as the File Requestor Interface 135 and the File Owner Interface 150 are used together to create a Means for requesting access 140 to the File 110 by the file requestor, a Means for responding 160 by the file owner to the file requestor, and if the file requestor is granted access to the File access permissions 130 by the file owner, a Means for accessing 145 the File 110. The details of the File Storage Area 105, the File Requestor Interface 135, the File Owner Interface 150 and the communications between the file requestor and file owner are described in detail elsewhere in this disclosure.

The Control Panel 155 with viewing and editing capabilities within the File Owner Interface 150 may further include at least one Time-Based Approval Period 400. During this Time-Based Approval Period 400, the file owner may or may not grant or deny the file requestor one or more File access permissions 130 as described in detail elsewhere in this application. Through the Means for granting access after the Time-Based Approval period 410 the file owner may set the Time-Based Approval Period 400 in any time increment, including but not limited to minutes, hours, days, weeks, months, years, etc. Through the Means for notifying the requestor 220, the file requestor may be provided a Notification of the Time-Based Approval Period 420 associated with the File 110.

During the Time-Based Approval Period 400, the Means for notifying the owner 200 may be used to send a notification of the expiration 430, reminding the file owner one or more times that after the expiration of the Time-Based Approval Period 400, the File access permissions 130 may be granted by default. Also during the Time-Based Approval Period 400, the file owner may use the viewing and editing capabilities of the Control Panel 155 or other elements of the File Owner Interface 150 as a Means for granting File access 240 or a Means for denying File access 250 in order to grant or deny File access permissions 130 to the file requestor respectively.

The Means for responding 160 within the File Owner Interface 150 may then be used to send a Notification of the grant or denial of access permissions 240 to the file requestor. The Means for notifying the requestor 220 within the File Requestor Interface 135 may be used to present to the file requestor Notification of the expiration of the Time-Based Approval Period 440. The Link 125 or other means of accessing the File 110 may be used as a Means for accessing the File 145, including downloading, transferring or any other means of accessing a file now known or later developed in the art.

After the expiration of the Time-Based Approval Period 400, the file requestor may automatically access the File 110 with or without additional limitations. Such additional limitations may include any of the Means for denying File access 250 discussed elsewhere in this disclosure.

In one non-limiting example embodiment, a request for automatic file access after the expiration of the Time-Based Approval Period 400 may be set as a default among several options available to the file owner, possibly within the Control Panel 155, regarding who may or may not have access to the File 110 and when such files may be available. Put another way, having a Time-Based Approval Period 400 in relation to a request is only one possible use of the Time-Based Approval Period 400. In additional embodiments, the File 110 may be made available to or denied from the file requestor or, in fact, any other users after the expiration of the Time-Based Approval Period 400 without the need of requesting the File 110.

A Method for Time-Based Document Storage Access

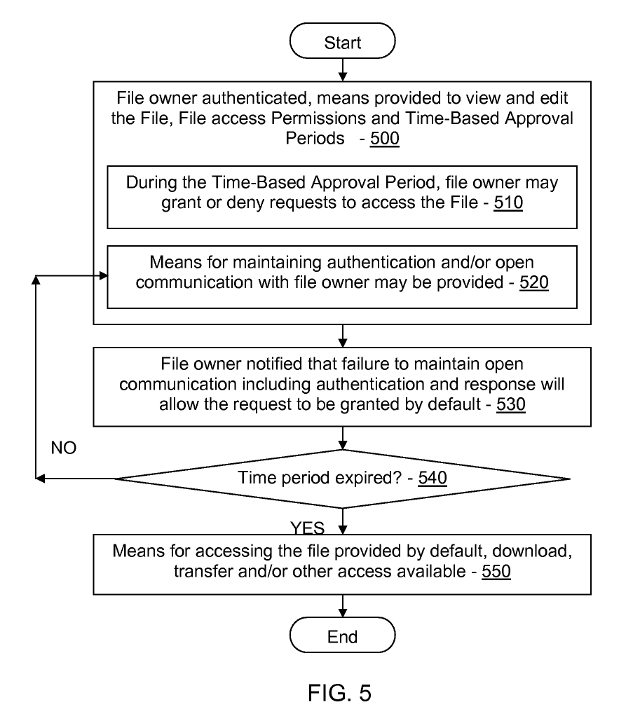

Several different methods may be used to provide and manage the disclosed invention. In an example embodiment illustrated in FIG. 5, a File Storage Area 105 may be provided containing at least one File 110 which belongs to a file owner wherein the file owner may, after proper authentication, grant or deny access to the File 110 during a Time-Based Approval Period 400, and after which the file requestor may automatically access the File 110 with or without additional limitations. Such additional limitations may include any of the Means for denying File access 250 previously discussed, or use of the Time-Based Approval Period 400 to deny access to the File 110 discussed in more detail below.

The process starts by having a means provided for the file owner, after proper Authentication 115, to view and edit the File 110, any associated File access permissions 130 and any related Time-Based Approval Periods 400 (Step 500).

During the Time Based Approval Period 400, the file owner may respond to any request to access the File 110 by granting or denying the request to access the File 110 and communicating the response to the file requestor (Step 510) as described in detail elsewhere in this disclosure.

In another embodiment, the request for access to the File 110 may not be required, so that the File 110 is simply made available for access/download/transfer, or denied after the expiration of the Time-Based Approval Period 400.

Because the expiration of the Time-Based Approval Period 400 may automatically grant the file requestor access to the File 110, means may be provided for maintaining open communication with the file owner. Means may also be provided for requiring proper authentication regularly to ensure open communication with the file owner (Step 520).

In order to ensure such notification, the file owner may be notified at least once that failure to maintain open communication as described above or to respond to a request during the Time-Based Approval Period 400 will allow the request to access the File 110 to be approved by default (Step 530). The means for notification may be set by the Hosting Provider 120 in any time increment, including but not limited to minutes, hours, days, weeks, months, years, etc.

Once the Time-Based Approval Period 400 has expired (Step 540), means may be provided for accessing the File 110 by default. In one embodiment, access to the File 110 is provided to a specific file requestor. In another embodiment, the File 110 will be made available to any file requestor. In another embodiment, the Link or other means of accessing the file 125 may include a Tag 170 or other means of marking the Link 125 which may contain information allowing the next attempted access of the Link or other means of accessing the file 125 to begin a download, transfer or other access of the File 110 (Step 550).

In another embodiment, the file owner may set the expiration of the Time-Based Approval Period 400 to not only grant the File access permissions 130, but also deny them. By way of non-limiting example, such a grant or denial may be similar to a pocket veto in politics. Just as the pocket veto may allow the President or Congress to indirectly allow or veto a bill based on the action or inaction of the President or Congress during a pre-set period of time, the action or inaction of the file owner or file requestor (or other users) during the running of the Time-Based Approval Period 400 may indirectly allow the grant or denial of File access permissions 130 to the file requestor or other users who desire use the File 110.

In a non-limiting example embodiment, the option for approval is time-based. The file owner may specify a number of days, weeks, months, years etc. after which a request for a document will automatically be approved. The steps within the simple approval mechanism may also be integrated, however, in the time-based approval embodiment, the file owner may be notified, possibly many times, that if the file owner fails to respond to the request within the pre-specified time period, the request may be approved by default. This may give the file owner a chance to deny the request, but may approve the request after the Time-Based Approval Period 400 has elapsed. This type of approval may serve as a “deliver this if I die” type of service, allowing people to store copies of legal documents, or “personal messages” that need to be delivered to others. File owners may give family members or friends a link and tell them only to use it when needed. Until the file owner is unable to respond for some period of time, access to the documents may easily be denied.

File owners may still immediately approve/deny requests if they wish. A mechanism may also be provided where the owner is periodically emailed to ensure an open communication channel exists and/or that the file owner has logged in periodically. Such an open communication channel may further include proper authentication, accessing the means for the file owner to view and edit the File, response to a request, changing the Time-Based Approval Period, updating file owner contact information, monthly ping, any of the aforementioned or any combination thereof.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A system comprising:
a. a File Storage Area containing at least one File wherein the File Storage Area is accessible by a file owner after proper authentication, is hosted by a Hosting Provider and is communicatively coupled to a Network;
b. a Link or other means of accessing the File wherein the Link or the other means of accessing the File contains information about one or more access permissions associated with the File;
c. a File Requestor Interface accessible to a file requestor and communicatively coupled to the Network further comprising:
i. means for requesting access to the File;
ii. means for notifying the file requestor of a response to a request for access to the File; and
iii. means for accessing the File; and
d. a File Owner Interface accessible to the file owner and communicatively coupled to the Network further comprising:
i. a Control Panel comprising viewing and editing capabilities for the File and its associated access permissions;
ii. means for notifying the file owner of the request for access to the File;
iii. means for granting or denying the request for access to the File; and
iv. means for responding to the file requestor regarding the request for access to the File.

2. The system of claim 1 wherein the File Storage Area is hosted on a Server, a Computer, or any combination thereof.

3. The system of claim 1 wherein the means for requesting access to the File, the means for granting the request for access to the File and the means for accessing the File further comprise a metadata Tag embedded within the Link or other means of accessing the File which grants or denies the file requestor the ability to download or transfer the File subsequent to the grant or the denial of access to the File.

4. The system of claim 1 wherein the File Requestor Interface is displayed in conjunction with Client Software on a Client communicatively coupled to the Network.

5. The system of claim 1 wherein the File Requestor Interface further comprises access to a Requestor Email Account capable of displaying the Link or other means of accessing the File and any associated message.

6. The system of claim 1 wherein the File Requestor Interface further comprises means for notifying the file requestor that the request for access to the File has been received by the file owner.

7. The system of claim 1 wherein the File Owner Interface is displayed in conjunction with Client Software on a Client communicatively coupled to the Network.

8. The system of claim 1 wherein the File Owner Interface further comprises access to an Owner Email Account capable of sending the Link or other means of accessing the File and any associated message.

9. The system of claim 1 wherein the File Owner Interface further comprises means for tracking both requests for access to the File and access to the File.

10. A method comprising:
a. providing a File Storage Area containing at least one File belonging to a file owner wherein the file owner, after proper authentication, grants or denies access to the File;
b. allowing a file requestor to request access to the File from the file owner;
c. notifying the file owner of the request to access the File;
d. providing means for the file owner to view and edit the File and any associated access permissions and to respond to the request to access the File by granting or denying the request to access the File and communicating the response to the file requestor;
e. providing means for the file requestor to access the File, subsequent to a grant of access to the File; and
f. removing the means for the file requestor to access the File, subsequent to the file requestor successfully accessing the File.

11. The method of claim 10 wherein access to the File further comprises a Link or other means of accessing the File.

12. The method of claim 11 wherein the Link or other means of accessing the File further comprises a metadata Tag embedded within the Link or other means of accessing the File which allows the file requestor to download or transfer the File subsequent to the grant of access to the File.

13. The method of claim 12 wherein removing the means to access the file further comprises removal of the metadata Tag or removal of the Link or other means of accessing the File.

14. The method of claim 12 wherein the Link or other means of accessing the File is included in a communication between the file owner and the file requestor.

15. The method of claim 14 wherein communication between the file owner and the file requestor further comprises email, text messaging, instant messaging, desktop notification, monthly ping, or any combination thereof.

16. The method of claim 10 wherein the means for the file owner to view and edit the File and any associated access permissions and to respond to the request to access the File further comprises a File Owner Interface.

17. The method of claim 16 wherein the File Owner Interface further comprises means for tracking both requests for access to the File and access to the File.
